(19) United States
(12) Patent Application Publication
(10) Pub. No.: US 2025/0386845 A1
(43) Pub. Date: Dec. 25, 2025

(54) TENSILE-RESISTANT POTATO STARCH HYDROGEL AND PREPARATION METHOD THEREOF

(71) Applicant: Qingdao Agricultural University, Qingdao (CN)

(72) Inventors: Yang QIN, Qingdao (CN); Yajie YUAN, Qingdao (CN); Xingyu ZHANG, Qingdao (CN); Qingjie SUN, Qingdao (CN); Yunhao ZHOU, Qingdao (CN); Yunhao WANG, Qingdao (CN); Man LI, Qingdao (CN); Na JI, Qingdao (CN); Pengdong SUN, Qingdao (CN)

(73) Assignee: Qingdao Agricultural University, Qingdao (CN)

(21) Appl. No.: 19/241,418

(22) Filed: Jun. 18, 2025

(30) Foreign Application Priority Data
Jun. 20, 2024 (CN) 202410806347.9

(51) Int. Cl. A23L 29/212; C08J 3/075

(52) U.S. Cl. CPC A23L 29/212; C08J 3/075; C08J 2303/02

(57) ABSTRACT

A stretch-resistant potato starch hydrogel and a preparation method thereof are provided. The preparation method includes the following steps: S1, preparation of gel slices; S2, aging of gel slices; S3, rehydration of gel slices; s4, tensile property and texture property test: testing the tensile property and texture property of the rehydrated potato starch gel by TG probe of a texture analyzer; S5, determining the optimal aging time, rehydration temperature and rehydration time of the potato starch hydrogel. The invention uses the above-mentioned stretch-resistant potato starch hydrogel and the preparation method thereof to obtain the starch hydrogel PSH₋₁₈-100-20S with excellent tensile strength, and the tensile strength is 750%-800%. The preparation parameters are determined, which provides a theoretical basis for the application of starch hydrogel in food.

### CROSS REFERENCE TO THE RELATED APPLICATIONS

This application is based upon and claims priority to Chinese Patent Application No. 202410806347.9, filed on Jun. 20, 2024, the entire contents of which are incorporated herein by reference.

### TECHNICAL FIELD

The invention relates to the field of starch hydrogel technology, in particular to a tensile-resistant potato starch hydrogel and a preparation method thereof.

### BACKGROUND

Natural starch is polymerized from dextran, mainly amylose and amylopectin (Zhang et al., 2023). Compared with other natural starches, potato starch has a phosphate group inside the molecule, and the negative charges between the groups repel each other to form unique physical and chemical properties, the gelatinization temperature is lower, it is easy to gelatinize and expand, and the viscosity and transparency of the gelatinized starch are higher (Maetal., 2023). In the industrial production of starch foods, the gelatinization and degradation process will lead to changes in the microstructure and mechanical properties of starch gels, which will directly affect the quality of the products. Therefore, how to regulate the gelatinization and degradation of starch hydrogels and improve product quality still needs to be continuously explored (Chang, Zheng, Zhang, & Zeng, 2021). Starch degradation is a process in which starch granules absorb a large amount of water under heating, expand, and rupture, the intermolecular interaction force between starch granules is destroyed, and the starch structure becomes disordered; the gelatinized starch spontaneously reunites into an ordered structure during cooling at low or room temperature; the starch depolymerization is also divided into long-term depolymerization and short-term depolymerization, the short-term depolymerization occurs in the early cooling stage of gelatinized starch, amylose is entangled with each other through hydrogen bonds, and the molecular chains are rearranged and polymerized to form a starch gel with certain hardness and elasticity. Long-term aging is mainly due to the long-term regeneration caused by the recrystallization of the outer chain of linear starch, which is a long-term process and leads to the decline of starch food quality (Jiang et al., 2021).

Factors such as aging temperature, aging time, and starch composition (amylose and amylopectin) have an impact on the aging process. Temperature is the main factor affecting starch degradation, it is found that starch begins to degrade when the gelatinized starch is cooled; freezing can adjust the mechanical properties of starch by improving its microstructure (Chen, Singh, Midgley, & Archer, 2020). During the aging process, different temperatures will affect the nucleation type of starch molecules, which in turn affects the aging rate of starch. It has been reported at home and abroad that the network structure and mechanical properties of starch gels can be controlled by room temperature (25° C.), low temperature (4° C.), and room temperature/low-temperature cycle aging (Satmalee & Charoenrein, 2009). The results show that low-temperature aging makes it easier to form an ordered crystal structure of starch molecules than normal-temperature aging, thus accelerating the aging rate of starch gel and forming higher gel strength and toughness. Han et al. studied the effects of high temperature (50° C.) and low temperature aging on the quality of rice noodles, and found that the cooking loss of rice noodles after low-temperature aging treatment is significantly reduced and the texture properties are improved (Han, Seo, Lim, & Park, 2011). Gong et al. found that the quick-freezing temperature will affect the quality of oat roll products; quick-freezing at −40° C. and −80° C. can inhibit the enthalpy and order of the starch gel, delay the growth of ice crystals, protect the internal structure of starch gel, and improve product quality. (Gong et al., 2020). Jia et al. also found that the frozen potato starch gel maintains the shape of starch granules and improves the quality of surimi (Jia et al., 2018); therefore, there are significant differences in the mechanical properties, rehydration and microstructure of starch gels aged at different temperatures (Jiang et al., 2020); at present, many researchers have found that starch gel products with porous network structure can be manufactured by adding enzymes and using various drying methods such as vacuum freezing to enhance the mechanical properties of the gel and reduce the time required for rehydration (Zhang et al., 2022); the porous structure can increase the specific surface area and promote the migration of water molecules, so it is generally believed that the larger pore size contributes to the rehydration of the dry surface (Zhang et al., 2024).

Therefore, this application takes potato starch as the starting point to study the effect of micro-network structure differences formed by aging treatment at different temperatures (25° C., 4° C., −18° C., −30° C.) on the rehydration and mechanical properties of potato starch hydrogel, the water distribution of starch gel is determined by low-field nuclear magnetic resonance relaxation time, the micro-pore size of the gel is determined by scanning electron microscopy, and the short-range order of the gel is determined by Fourier transform infrared spectroscopy, the mechanical properties of starch gel after rehydration at different temperatures are analyzed.

### SUMMARY

The purpose of the invention is to provide a tensile-resistant potato starch hydrogel and a preparation method thereof, the starch hydrogel PSH₋₁₈-100-20S with excellent tensile strength is obtained, and the tensile strength is 750%-800%, the preparation parameters are determined, which provides a theoretical basis for the application of starch hydrogel in food.

To achieve the above purpose, the invention provides a preparation method for an anti-stretch potato starch hydrogel, including the following steps:
S1, preparation of gel slices: mixing potato starch and deionized water in proportion, stirring evenly to form a slurry, pouring 4 mL of slurry into a silica gel mold each time, and placing a mold containing a slurry sample in a steamer, after boiling for 3-4 min, obtaining potato starch gel slices, sealing the potato gel slices and cooling at room temperature;
S2, aging of gel slices: obtaining PSH₂₅, PSH₄, PSH₋₁₈, and PSH₋₃₀ by aging the cooled potato starch gel slices for 12 h;
S3, rehydration of gel slices: rehydrating PSH₂₅, PSH₄, PSH₋₁₈, and PSH₋₃₀ to obtain a potato starch hydrogel PSHₓ-Y-Z, where X is an aging temperature of the potato starch gel, Y is a rehydration temperature, and Z is a rehydration time;
S4, tensile property, and texture property test: testing the tensile property and texture property of the rehydrated potato starch gel by TG probe of a texture analyzer;
S5, determining an optimal aging time, rehydration temperature, and rehydration time of the potato starch hydrogel.

Furthermore, a w/v ratio of potato starch to deionized water in S1 is 2: (2-3.5), and a thickness of the potato starch gel slices is 1.5-3.0 mm.

Furthermore, the aging temperatures of the potato starch gel slices in S2 are 25° C., 4° C., −18° C., −30° C.

Furthermore, the rehydration temperatures in S3 are 70° C., 85° C., 100° C., and the rehydration times are 10 s, 20 s, 30 s, 40 s, 50 s.

Furthermore, the specific operation of the tensile property test in S4 is as follows: drying a surface of the rehydrated potato starch hydrogel, and selecting the potato starch gel with uniform thickness for measurement to obtain a stress-strain curve; setting parameters as follows: automatic displacement trigger mode, a speed before the test is 3 mm/s, a speed during the test is 1 mm/s, a speed after the test is 3 mm/s, a sample width is 2 mm, a length is 18 mm, and a strain height is 10 mm.

Furthermore, the specific operation of a texture property test in S4 is as follows: drying the surface of the rehydrated potato starch hydrogel, and selecting the potato starch gel with uniform thickness for measurement; the parameters are set as follows: the speed is 0.5 mm/s, a morphology is 50%, a pre-test and post-test speed is 3 mm/s, and a trigger force is 5 g, obtaining a force-time curve by texture analysis, obtaining texture parameters, including hardness, viscosity, elasticity, adhesion and chewiness.

Furthermore, the optimal aging time of the potato starch hydrogel in S5 is −18° C., the optimal rehydration temperature is 100° C., and the optimal rehydration time is 20 s.

Furthermore, the tensile strength of the potato starch hydrogel is 750%-800% under the conditions of optimal aging time, optimal rehydration temperature and optimal rehydration time.

The invention also provides a potato starch hydrogel prepared by the above preparation method.

The advantages and positive effects of the tensile-resistant potato starch hydrogel and the preparation method thereof described in the invention are as follows:
1. The changes of rehydration properties and mechanical properties of potato starch hydrogels under different microstructures are studied, the results show that it is effective to improve the rehydration properties and mechanical properties of potato starch hydrogels at appropriate cooking temperature.
2. The starch hydrogel PSH₋₁₈-100-20S with excellent tensile strength is obtained in this application, and the tensile strength is 750%-800%, the preparation parameters are determined, which provide a theoretical basis for the application of starch hydrogel in food.

The following is a further detailed description of the technical scheme of the invention through drawings and embodiments.

### BRIEF DESCRIPTION OF THE DRAWINGS

FIGS. 1A-1L are tensile results of the rehydrated PSH sample in the embodiment of the invention;

FIGS. 2A-2L are spin relaxation time of the potato starch gel at different aging temperatures and rehydration temperatures in the embodiment of the invention;

FIGS. 3A-3L are MRI images of the potato starch gel in the embodiment of the invention;

FIGS. 4A-4D are the gel microstructures of the potato starch gel regenerated at different temperatures and rehydrated at different temperatures in the embodiment of the invention; the aging temperature of FIG. 4A is 25° C., the aging temperature of FIG. 4B is 4° C., the aging temperature of FIG. 4C is −18° C., and the aging temperature of FIG. 4D is −30° C.

FIGS. 5A-5K are infrared spectra of the potato starch gel under different regeneration temperatures and different rehydration conditions in the embodiment of the invention.

FIGS. 6A-6D are artificial stretching of PSH₂₅, PSH₄, PSH₋₁₈, and PSH₋₃₀ after rehydration at different times in the embodiment of the invention.

FIG. 7 is a water content of PSH at different aging temperatures and different rehydration temperatures and times due to the short rehydration time in the cooking process of the embodiment of the invention.

### DETAILED DESCRIPTION OF THE EMBODIMENTS

The following is a further explanation of the technical scheme of the invention through drawings and embodiments.

Unless otherwise defined, the technical terms or scientific terms used in the invention should be understood by people with general skills in the field to which the invention belongs.

The experimental materials such as potato starch in this application are conventionally sold on the market.

### Embodiment

### 1. Sample Preparation:

### 1.1 Preparation of the Potato Starch Hydrogel:

Potato starch and deionized water were mixed at a ratio of 2:3 (w/v) and stirred evenly to form a slurry. 4 mL of slurry was poured into the silica gel mold each time. The mold containing the slurry sample was placed in a steamer and boiled with boiling water for 4 min to obtain a potato starch gel sheet with a thickness of about 2 mm.

### 1.2 Aging of the Potato Starch Hydrogel:

The potato gel sheet was sealed and cooled at room temperature, the cooled potato gel was aged at different temperatures (25° C., 4° C., −18° C., −30° C.) for 12 h to obtain PSH₂₅, PSH₄, PSH₋₁₈ and PSH₋₃₀.

### 1.3 Rehydration of the Potato Starch Hydrogel:

The aged potato starch gel was rehydrated at different temperatures for different times to obtain PSHₓ-Y-Z, where X was the aging temperature of the potato starch gel, Y was the rehydration temperature, and Z was the rehydration time for subsequent experiments. The rehydration temperatures were 70° C., 85° C., 100° C., and the rehydration time were 10 s, 20 s, 30 s, 40 s, 50 s.

### 1.4 Tensile Properties of Potato Starch Hydrogel PSH:

The tensile properties of the rehydrated potato starch gel were tested by the TG probe of a texture analyzer. The surface water of rehydrated PSH was dried, and the potato starch gel with uniform thickness was selected for measurement, each sample was measured at least 5 times to obtain the stress-strain curve. The parameters were set to the automatic displacement trigger mode, the speed before the test was 3 mm/s, the speed during the test was 1 mm/s, and the speed after the test was 3 mm/s, the width of the sample was 2 mm, the length was 18 mm, and the strain height was 10 mm.

### 1.5 Texture Properties of the Potato Starch Hydrogel:

The texture properties of rehydrated potato starch gel were tested by TG probe of a texture analyzer, the PSH surface was dried and the potato starch gel with uniform thickness was selected for measurement, each sample was measured at least 5 times. The velocity was 0.5 mm/s, the morphology was 50%, the velocity before and after the measurement was 3 mm/s, and the trigger force was 5 g. The texture parameters including hardness, viscosity, elasticity, adhesion, and chewiness were obtained by using the force-time curve of texture analysis.

### 1.6 Moisture Distribution of Potato Starch Hydrogel During Rehydration:

The water distribution of potato starch hydrogel samples was analyzed by low field nuclear magnetic resonance (NMR) analyzer. The potato starch hydrogel with uniform thickness was wrapped in a film to prevent water loss, it was loaded into a 40 mm diameter NMR tube and placed in the center of the RF coil in the center of the permanent magnetic field for CPMG sequence determination. Each sample was measured three times, and the data were reversed after the test. The relaxation time and area ratio characteristics of the following populations were determined: T21, T22, and T23; and A21, A22, A23. The data were analyzed by using the MultiExpInvAnalysis software. Each sample was examined five times, and then the average value was determined.

Magnetic resonance imaging (MRI) describes the water migration process inside PSH during rehydration. Magnetic resonance images were collected using a standard SPIN-ECHO (SE) imaging sequence. Instrument parameters TR=500 ms, TE=20 ms, RG=20 db. MRI image processing software imaging pseudo-coloring.

### 1.7 Scanning Electron Microscopy of the Potato Starch Hydrogel During Water Replenishment:

The potato starch gel aged at different temperatures and the hydrogel rehydrated under different conditions were freeze-dried and placed on an aluminum carrier table bonded with conductive tape and sprayed with gold. The network structure of the gel after freeze-drying was observed by scanning electron microscopy.

### 1.8 Fourier Transform Infrared (FTIR):

The Nicolet6700FTIR spectrometer was used for testing. Infrared characterization was carried out by Fourier transform infrared spectroscopy (FTIR), and the previous method was slightly modified, specifically, the aged freeze-dried potato starch gel was ground into a uniform fine powder foam and sieved through a 100 mesh sieve; the parameters were as follows: the air was used as the background, the scanning range was 400-4000 cm⁻¹, the scanning times are 64 times. After the scanning, the baseline correction and curve smoothing of the spectrum were carried out by OMNIC8.0, and the deconvolution was carried out, the data were derived to calculate 1047 cm⁻¹/1022 cm⁻¹, and the infrared spectrum of potato starch gel was finally obtained.

### 1.9 Statistical Analysis:

All experiments were repeated at least three times, and the results were analyzed by variance analysis and Duncan test using SPSS software version 25.0, the mean difference was compared at the 0.05 confidence level. When p<0.05, we believe that the difference was statistically significant. All images were created by Origin8.5 software.

### 2. Results:

### 2.1 Tensile Properties of the Rehydrated Potato Starch Gel:

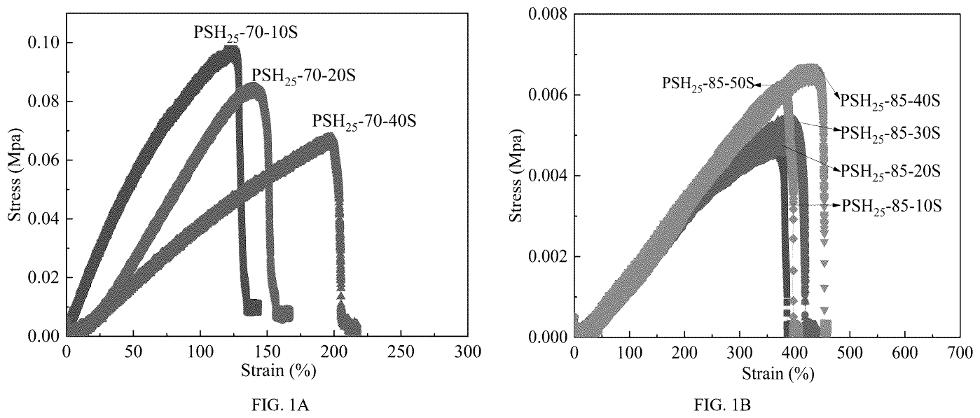

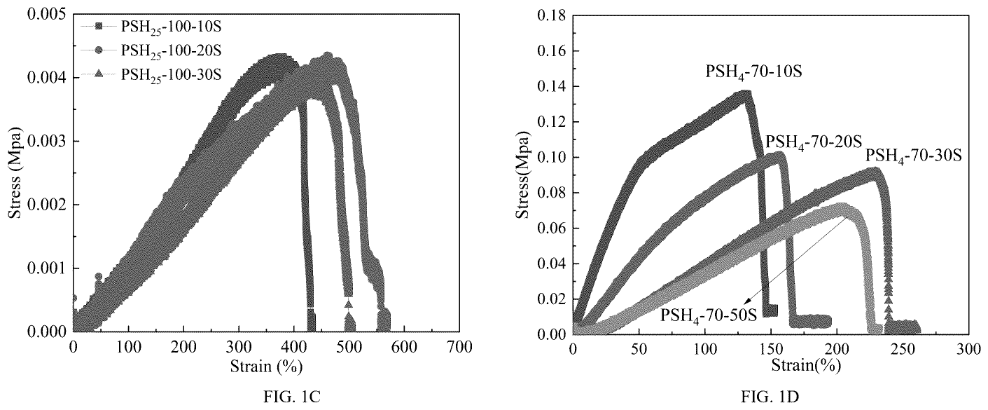

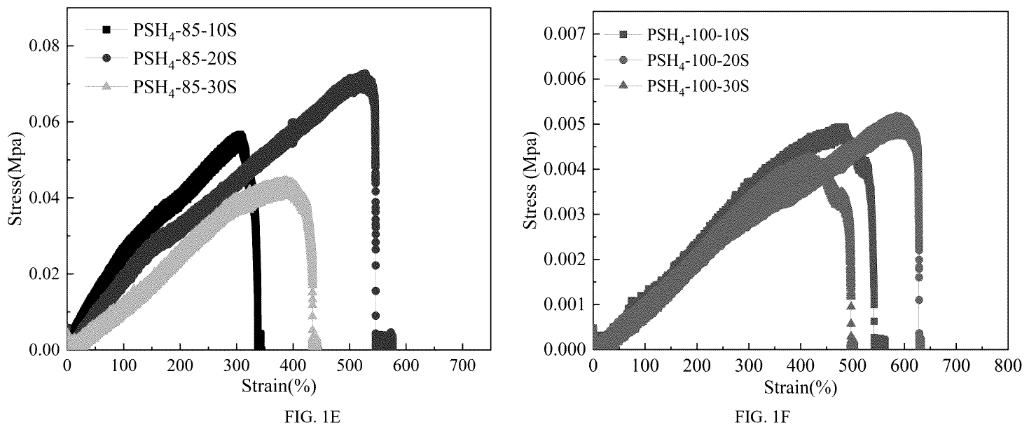

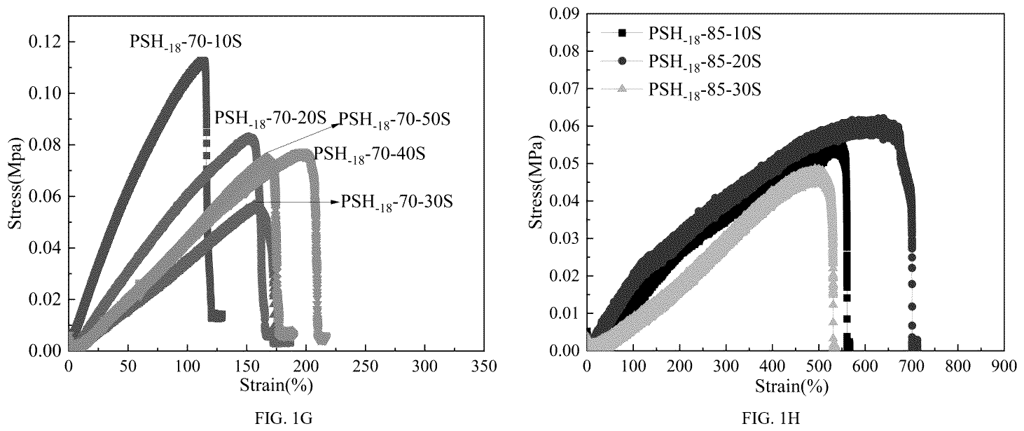

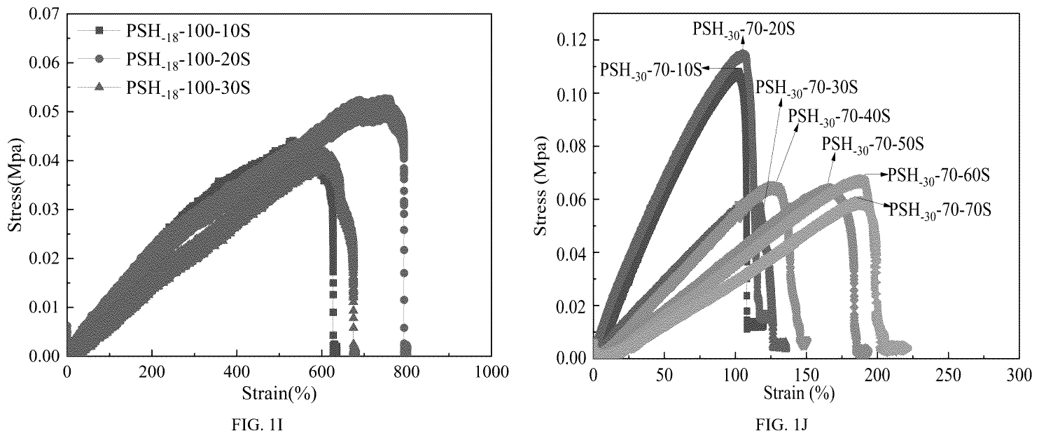

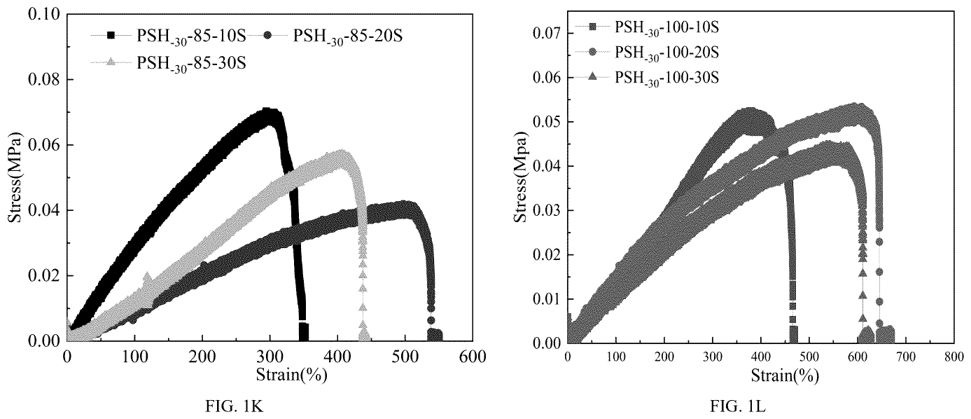

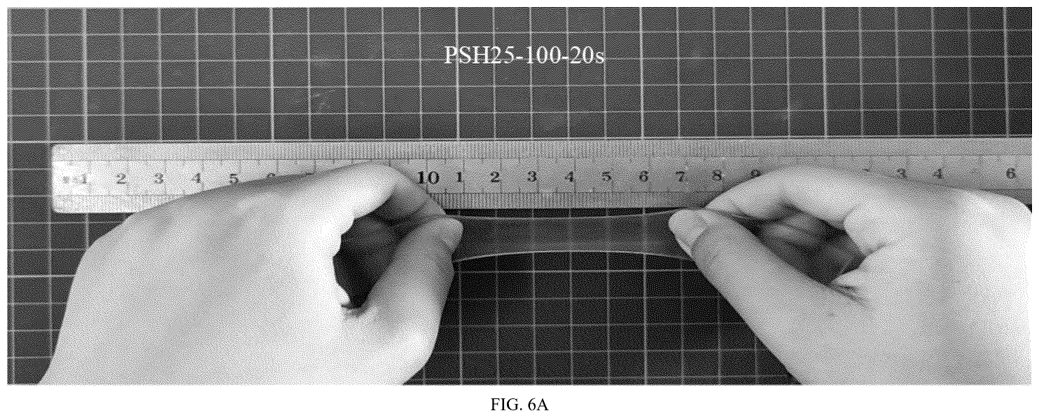

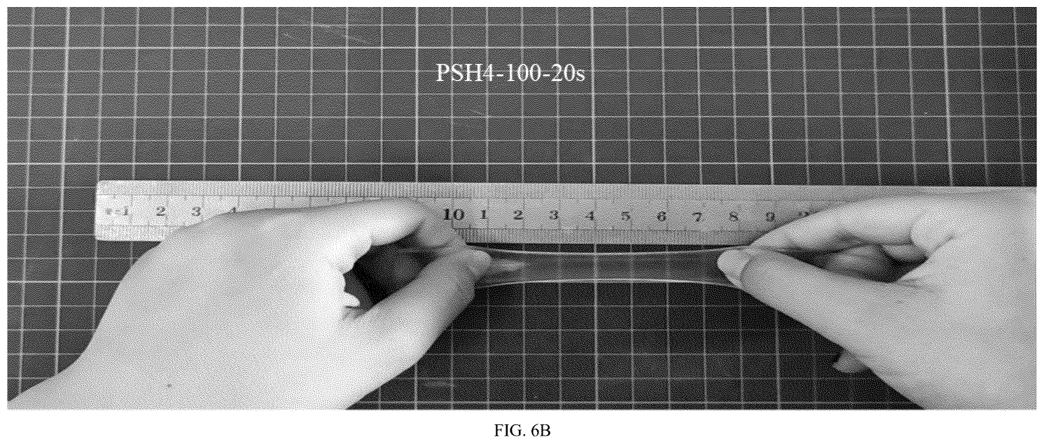

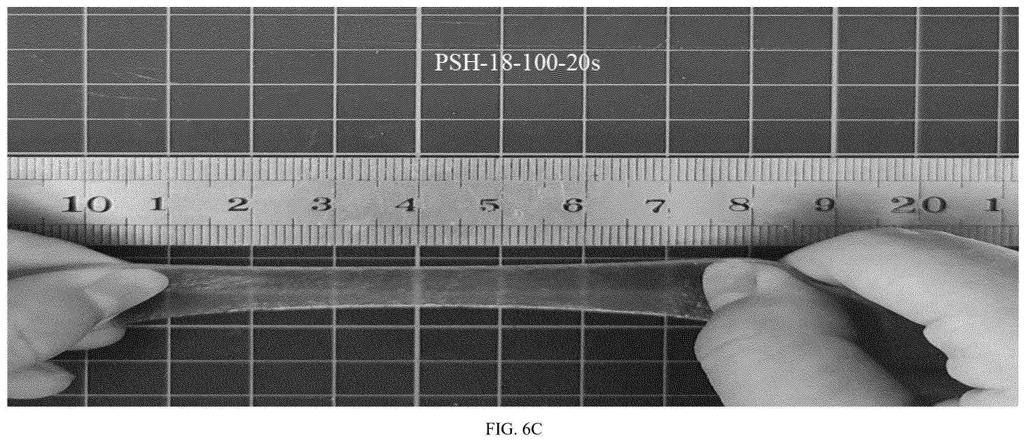

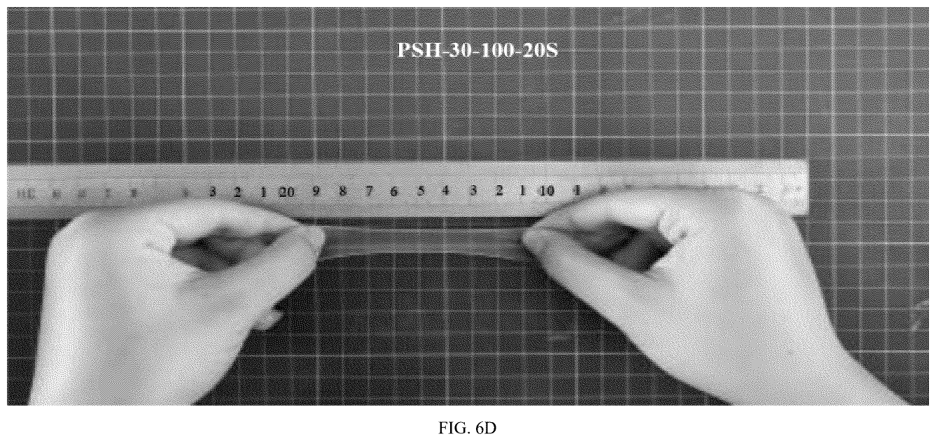

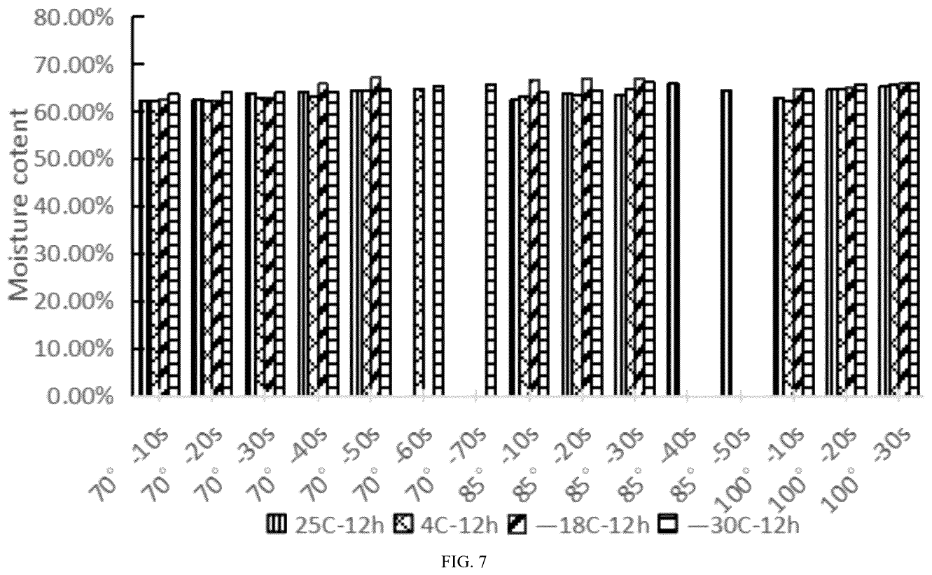

FIGS. 1A-1L are the tensile results of the rehydrated PSH samples. PSH showed significant differences in the aging temperature changes from room temperature 25° C., 4° C. to low temperature. The mechanical properties of P₋₁₈SH-100 were much better than those of the potato starch hydrogels aged at the other four temperatures, the strain of PSH₋₁₈-100-20S sample after rehydration was between 750% and 800%, and the tensile strength was higher than that of PSH₄-100-20S and other samples (620%-680%), indicating that when the gel was aged at −18° C., the frozen water in the starch gel could form a large number of small and dense ice crystals, which had less damage to the structure of the starch gel. Therefore, when the starch gel was aged at −18° C., its stress was lower than other PSH, and the tensile strength was higher. This observation could be attributed to the presence of microstructural changes during freezing, it had been reported that freezing can shorten the rehydration time by accelerating the water absorption of noodles. In addition, the microporous structure also reduced the amount of water required for rehydration. The rehydration experiment of the potato starch gel under the same degradation conditions showed that the tensile strain value increased first and then decreased as the rehydration process continued. This may be due to the long rehydration time of the potato starch gel, which led to the swelling of the starch gel and the destruction of hydrogen bonds between starch molecules, resulting in the decrease of the tensile strain of PSH, high-temperature conditions accelerating the migration of water molecules in starch and promote the interaction between water molecules and starch gel. Therefore, the tensile strain of PSH was the largest under the ideal rehydration temperature and rehydration time. In addition, FIGS. 6A-6D showed the artificial stretching of PSH₂₅, PSH₄, PSH₋₁₈, and PSH₋₃₀ after different time rehydration, which also proved that high temperature and short time rehydration are more conducive to the improvement of PSH tensile properties.

### 2.2 Texture Properties of Potato Starch Hydrogel:

Table 1, Table 2, Table 3, and Table 4 showed the effects of rehydration temperature and aging temperature on the texture properties of PSH.

TABLE 1

| | Hardness(g) | Springiness | Cohesiveness | Gumminess | Chewiness | Resilience |
|---|---|---|---|---|---|---|
| PSH₂₅- | 4924.43 ± | 1.03 ± | 0.92 ± | 4503.67 ± | 4661.76 ± | 0.57 ± |
| 70-10 s | 190.98 | 0.17 | 0.03 | 227.54 | 206.80 | 0.02 |
| PSH₂₅- | 4764.17 ± | 0.99 ± | 0.95 ± | 3556.92 ± | 3554.34 ± | 0.52 ± |
| 70-20 s | 169.20 | 0.056 | 0.02 | 193.18 | 307.32 | 0.01 |
| PSH₂₅- | 3506.53 ± | 0.94 ± | 0.95 ± | 4259.62 ± | 4008.05 ± | 0.50 ± |
| 70-40 s | 289.92 | 0.03 | 0.01 | 33.19 | 170.32 | 0.02 |
| PSH₂₅- | 3250.03 ± | 0.93 ± | 0.88 ± | 2855.50 ± | 2660.72 ± | 0.49 ± |
| 85-10 s | 181.32 | 0.01 | 0.03 | 258.65 | 62.22 | 0.02 |
| PSH₂₅- | 2400.88 ± | 0.93 ± | 0.87 ± | 2090.48 ± | 1934.70 ± | 0.43 ± |
| 85-20 s | 225.65 | 0.02 | 0.01 | 176.55 | 70.11 | 0.02 |
| PSH₂₅- | 2209.69 ± | 0.92 ± | 0.88 ± | 1940.14 ± | 1788.76 ± | 0.41 ± |
| 85-30 s | 209.73 | 0.01 | 0.02 | 133.20 | 108.22 | 0.01 |
| PSH₂₅- | 1982.07 ± | 0.90 ± | 0.88 ± | 1753.12 ± | 1574.56 ± | 0.52 ± |
| 100-10 s | 185.02 | 0.03 | 0.04 | 199.61 | 126.25 | 0.01 |
| PSH₂₅- | 2052.96 ± | 0.92 ± | 0.89 ± | 1836.30 ± | 1682.70 ± | 0.43 ± |
| 100-20 s | 108.39 | 0.05 | 0.03 | 70.84 | 125.76 | 0.02 |
| PSH₂₅- | 2107.97 ± | 0.92 ± | 0.92 ± | 1928.70 ± | 1752.56 ± | 0.37 ± |
| 100-30 s | 259.09 | 0.02 | 0.07 | 97.87 | 129.62 | 0.01 |

TABLE 2

| | Hardness | Springiness | Cohesiveness | Gumminess | Chewiness | Resilience |
|---|---|---|---|---|---|---|
| PSH₄-70- | 8492.79 ± | 0.98 ± | 0.96 ± | 8166.63 ± | 8078.13 ± | 0.69 ± |
| 10 | 463.37 | 0.01 | 0.01 | 94.84 | 360.74 | 0.094 |
| PSH₄-70- | 5867.62 ± | 0.96 ± | 0.90 ± | 4919.90 ± | 4737.10 ± | 0.52 ± |
| 20 s | 170.22 | 0.01 | 0.02 | 454.88 | 321.20 | 0.04 |
| PSH₄-70- | 4302.57 ± | 0.96 ± | 0.94 ± | 4045.00 ± | 3883.67 ± | 0.45 ± |
| 50 s | 3.39 | 0.02 | 0.01 | 256.766 | 16.25 | 0.01 |
| PSH₄-85- | 5074.65 ± | 0.96 ± | 0.84 ± | 4270.48 ± | 4084.06 ± | 0.46 ± |
| 10 s | 97.95 | 0.01 | 0.02 | 220.52 | 163.77 | 0.01 |
| PSH₄-85- | 3154.37 ± | 0.95 ± | 0.92 ± | 2886.05 ± | 2597.20 ± | 0.38 ± |
| 20 s | 213.34 | 0.03 | 0.05 | 23.98 | 67.76 | 0.01 |
| PSH₄-85- | 4130.15 ± | 0.94 ± | 0.92 ± | 3909.87 ± | 3687.30 ± | 0.41 ± |
| 30 s | 273.58 | 0.01 | 0.06 | 9.47 | 43.40 | 0.03 |
| PSH₄-100- | 4256.73 ± | 0.92 ± | 0.87 ± | 3710.96 ± | 3270.12 ± | 0.55 ± |
| 10 s | 203.90 | 0.02 | 0.08 | 146.35 | 216.54 | 0.02 |
| PSH₄-100- | 4031.98 ± | 0.93 ± | 0.85 ± | 3933.93 ± | 3725.55 ± | 0.50 ± |
| 20 s | 21.74 | 0.02 | 0.11 | 264.97 | 215.27 | 0.01 |
| PSH₄-100- | 3080.16 ± | 0.91 ± | 0.91 ± | 2800.15 ± | 2538.72 ± | 0.45 ± |
| 30 s | 154.76 | 0.01 | 0.09 | 146.99 | 129.25 | 0.12 |

TABLE 3

| | Hardness | Springiness | Cohesiveness | Gumminess | Chewiness | Resilience |
|---|---|---|---|---|---|---|
| PSH₋₁₈-70- | 4790.13 ± | 0.94 ± | 0.90 ± | 4322.62 ± | 3636.65 ± | 0.5645 ± |
| 10 | 195.4 | 0.02 | 0.02 | 91.76 | 218..38 | 0.01 |
| PSH₋₁₈-70- | 4641.88 ± | 0.96 ± | 0.96 ± | 5432.01 ± | 5232.90 ± | 0.563 ± |
| 20 s | 213.06 | 0.01 | 0.01 | 270.1 | 180.94 | 0.02 |
| PSH₋₁₈-70- | 4199.90 ± | 0.97 ± | 0.95 ± | 3999.47 ± | 3899.24 ± | 0.549 ± |
| 50 s | 121.41 | 0.01 | 0.03 | 220.33 | 182.63 | 0.01 |
| PSH₋₁₈-85- | 4355.6145 ± | 0.97 ± | 0.95 ± | 5082.89 ± | 5181.09 ± | 0.573 ± |
| 10 s | 126.92 | 0.01 | 0.03 | 4.25 | 184.07 | 0.03 |
| PSH₋₁₈-85- | 4264.88 ± | 0.96 ± | 0.97 ± | 4170.64 ± | 4006.48 ± | 0.5625 ± |
| 20 s | 218.38 | 0.03 | 0.01 | 207.14 | 42.20 | 0.01 |
| PSH₋₁₈-85- | 4254.52 ± | 0.96 ± | 0.90 ± | 5191.13 ± | 4498.67 ± | 0.534 ± |
| 30 s | 72.4 | 0.01 | 0.04 | 253.09 | 144.84 | 0.02 |
| PSH₋₁₈-100- | 3895.59 ± | 0.94 ± | 0.86 ± | 3514.51 ± | 2656.56 ± | 0.4505 ± |
| 10 s | 19.59 | 0.01 | 0.02 | 218.85 | 98.50 | 0.01 |
| PSH₋₁₈-100- | 2824.44 ± | 0.94 ± | 0.93 ± | 2640.24 ± | 2484.61 ± | 0.4045 ± |
| 20 s | 144.77 | 0.01 | 0.01 | 174.19 | 146.16 | 0.01 |
| PSH₋₁₈-100- | 2344.30 ± | 0.89 ± | 0.87 ± | 2062.80 ± | 1738.99 ± | 0.33 ± |
| 30 s | 73.32 | 0.03 | 0.02 | 118.75 | 102.68 | 0.01 |

TABLE 4

| | Hardness | Springiness | Cohesiveness | Gumminess | Chewiness | Resilience |
|---|---|---|---|---|---|---|
| PSH₋₃₀-70- | 7185.87 ± | 0.881 ± | 0.894 ± | 6427.63 ± | 4518.555 ± | 0.62 ± |
| 10 | 276.75 | 0.17 | 0.01 | 56.48 | 33.71 | 0.02 |
| PSH₋₃₀-70- | 4359.01 ± | 1.00 ± | 0.95 ± | 4067.8625 ± | 4058.16 ± | 0.61 ± |
| 20 s | 142.95 | 0.08 | 0.04 | 20.56 | 79.18 | 0.02 |
| PSH₋₃₀-70- | 4488.47 ± | 0.95 ± | 0.92 ± | 4142.5815 ± | 4040.87 ± | 0.48 ± |
| 60 s | 119.69 | 0.02 | 0.03 | 193.25 | 109.61 | 0.01 |
| PSH₋₃₀-85- | 4641.63 ± | 0.93 ± | 0.95 ± | 4663.925 ± | 4350.27 ± | 0.47 ± |
| 10 s | 104.02 | 0.02 | 0.02 | 44.04 | 127.94 | 0.01 |
| PSH₋₃₀-85- | 3990.86 ± | 0.97 ± | 0.95 ± | 3808.475 ± | 3699.48 ± | 0.49 ± |
| 20 s | 168.04 | 0.01 | 0.01 | 4.53 | 10.69 | 0.01 |
| PSH₋₃₀-85- | 3837.38 ± | 0.96 ± | 0.92 ± | 3745.5705 ± | 3599.86 ± | 0.48 ± |
| 30 s | 159.49 | 0.02 | 0.02 | 165.08 | 85.33 | 0.02 |
| PSH₋₃₀-100- | 3635.79 ± | 0.94 ± | 0.89 ± | 3687.8665 ± | 3477.71 ± | 0.48 ± |
| 10 s | 137.78 | 0.01 | 0.02 | 181.37 | 129.73 | 0.01 |
| PSH₋₃₀-100- | 2946.83 ± | 0.88 ± | 0.83 ± | 2460.265 ± | 2163.15 ± | 0.47 ± |
| 20 s | 194.45 | 0.02 | 0.03 | 40.00 | 45.38 | 0.011 |
| PSH₋₃₀-100- | 2222.36 ± | 0.89 ± | 0.88 ± | 1971.6865 ± | 1771.625 ± | 0.39 ± |
| 30 s | 126.40 | 0.02 | 0.01 | 74.65 | 91.23 | 0.01 |

There is no significant difference in the elasticity of PSH at different freezing temperatures (P>0.05). The aging of amylose leads to an increase in hardness. The hardness and chewiness of starch gel at −30° C. and −18° C. are lower than those at 4° C. We speculate that the increase in hardness under quick freezing is lower than that at 4° C. PSH is hardened by starch degradation, but the water molecules in the starch gel are rapidly frozen to form a stable and dense ice crystal structure during aging under freezing conditions, the formation of ice crystals leads to the fracture of the ordered structure of the starch gel, thereby inhibiting the aging of the potato starch gel. Therefore, the hardness of potatoes under freezing conditions is less than 4° C. aging. When the aging temperature decreases from 4° C. to −30° C., the hardness of the gel decreases significantly from 3080.16+154.76 (PSH₄-100-30s) to 2222.36+26.40 g (PSH₋₃₀-100-30s). The tiny ice crystals produced by the rapid freezing of the hydrogel have less effect on the elasticity, because they retain the internal structure by less damage to the microstructure. With the increase in rehydration temperature, the hardness of potato starch gel decreases steadily during the rehydration process, because the starch absorbs water and expands, exerts pressure on the gel, and increases its strength. Studies have shown that cooking temperature significantly affects the digestibility of starch, and the digestibility of starch has a significant effect on the texture of starch products. Specifically, the chewing force and hardness levels of all PSH samples decreased with the increase in rehydration temperature. As shown in Table 4, for the PSH₋₁₈-100-20S sample, the hardness decreases from 4790.13 to 2344.30 as the water temperature increases from 70° C. to 100° C. After rehydration, the chewiness and resilience of PSH₋₁₈-100-20 also decrease to 1738.99 and 0.33, respectively. At the same time, the rehydration time may also affect the texture characteristics of the potato starch gel. Long-term rehydration will destroy the structural integrity of the gel, overflow the content, and disturb the orientation of the gel. Previous studies have shown that appropriate aging conditions, coupled with the temperature and time of rehydration, can enhance the texture characteristics of rehydrated starch gels during aging.

### 2.3 Moisture Migration:

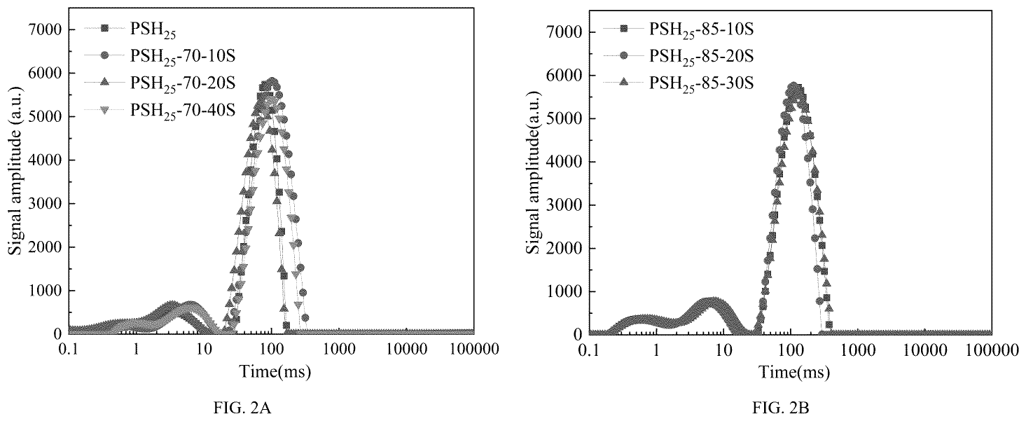

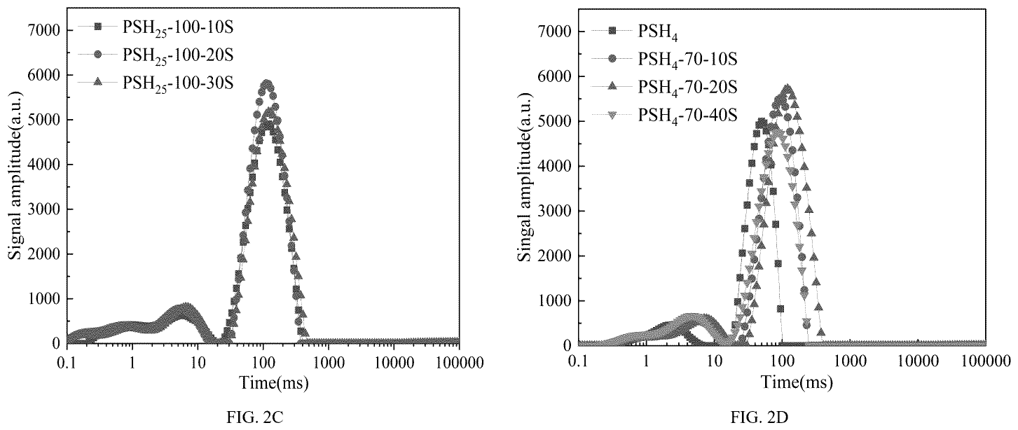

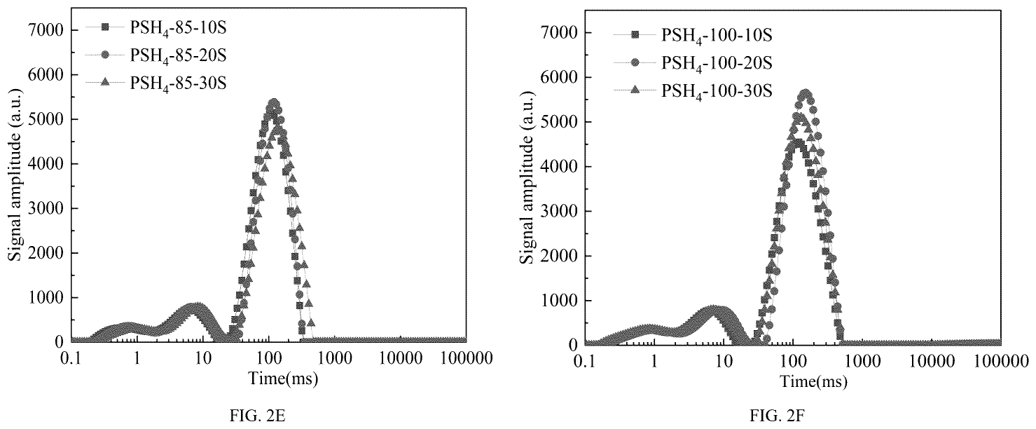

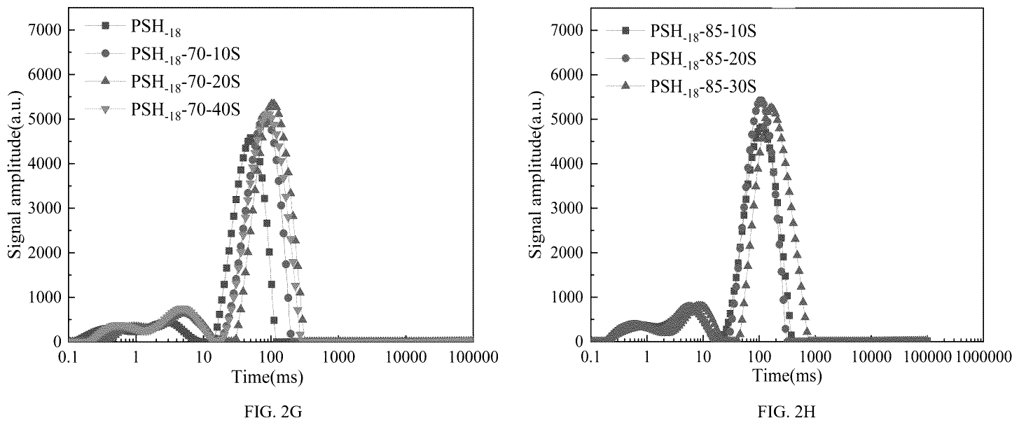

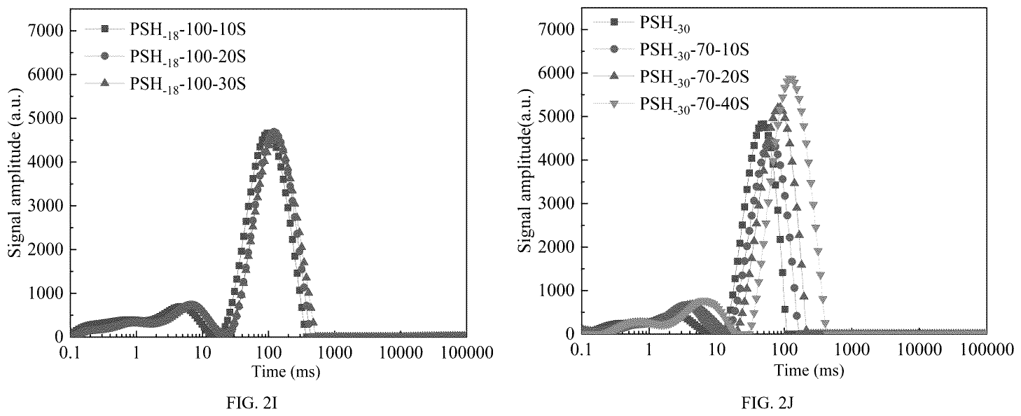

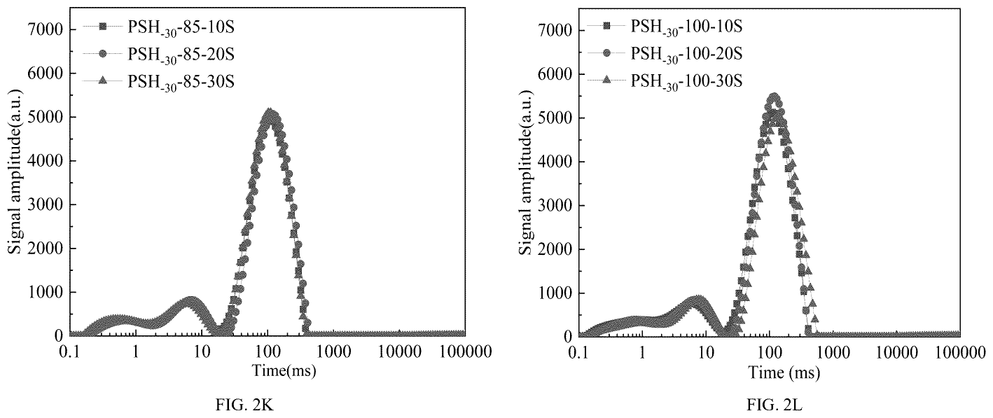

FIGS. 2A-2L are the spin relaxation time of the potato starch gel at different aging temperatures and rehydration temperatures. Three peaks can be observed in the sample, which are recorded as T21, T22, and T23, respectively, the peak area ratios of the three peaks represent different types of water content, recorded as A21, A22, and A23, respectively, indicating that there are multi-component water in the potato starch gel during aging and rehydration. The distribution range of T23 is 30-1000 ms, which is mainly related to the free water in the starch hydrogel network, the distribution range of T22 is 1-10 ms, corresponding to the less active water body. The bound or rigid water distribution (T21) ranges from 0.1 to 1 ms and is considered to be the lowest liquid water. Compared with T21 and T22, the area ratio of T23 is the highest, indicating that the rehydration of PSH is mainly affected by the increase of free water, which reflects the weak interaction between water and starch. Compared with the gel relaxation time at 4° C., the T23 values of the frozen gel samples after 12 h of regeneration are larger and the T22 values are smaller, indicating that the gel freezing and ice crystal melting lead to an increase in the pore size of the gel. Under the gel freezing condition, the starch gel basically does not regenerate, the water flow in the gel increases, and A23 increases. The interaction between water and starch gel is weak, and the migration of water after freezing may be due to the growth of ice crystals. Under the same aging conditions, with the increase of rehydration temperature, the areas of A23 and A22 gradually increase, indicating that at these three rehydration temperatures, when the rehydration temperature is higher, the migration rate of the gel water molecules is faster, and the water molecules are mainly located in the flowing water outside the starch granules; the interaction with starch gel is weak, and the ability of PSH to bind water increases with the increase of rehydration temperature and time.

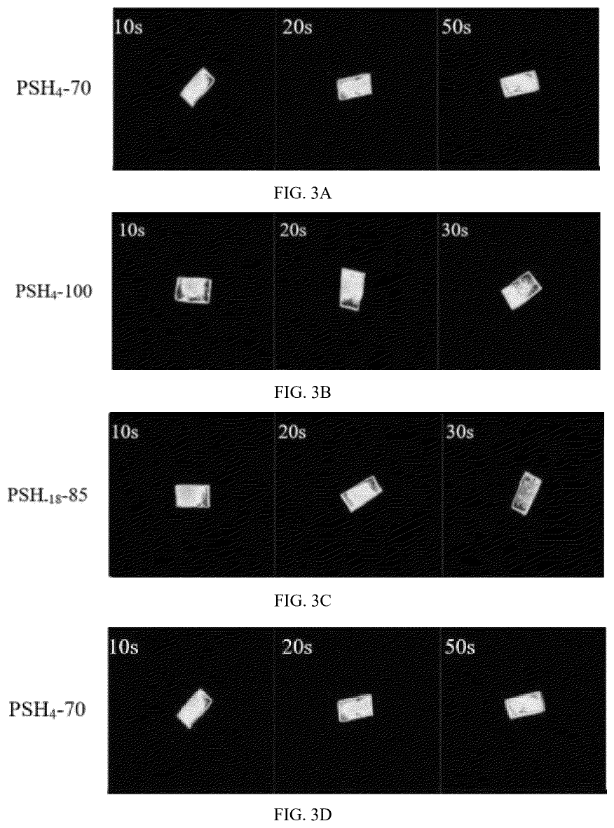

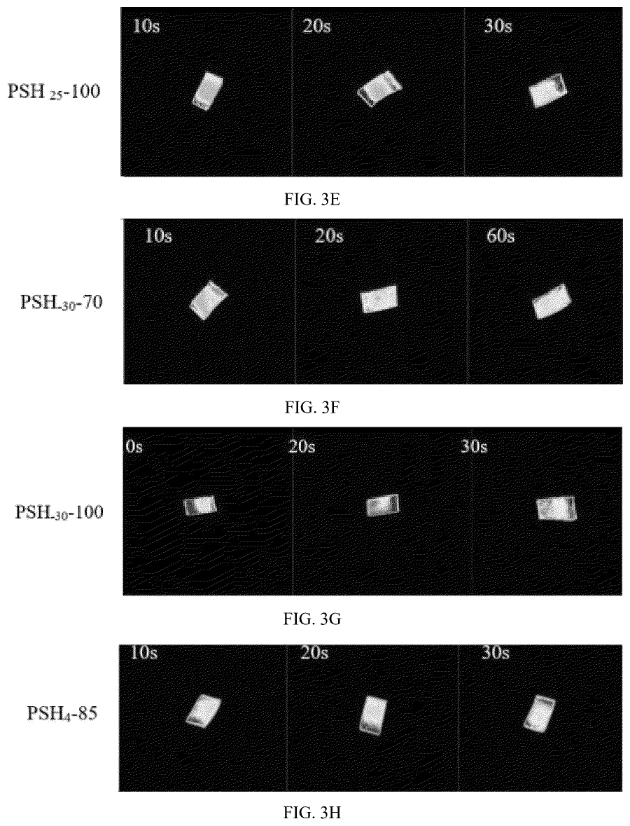

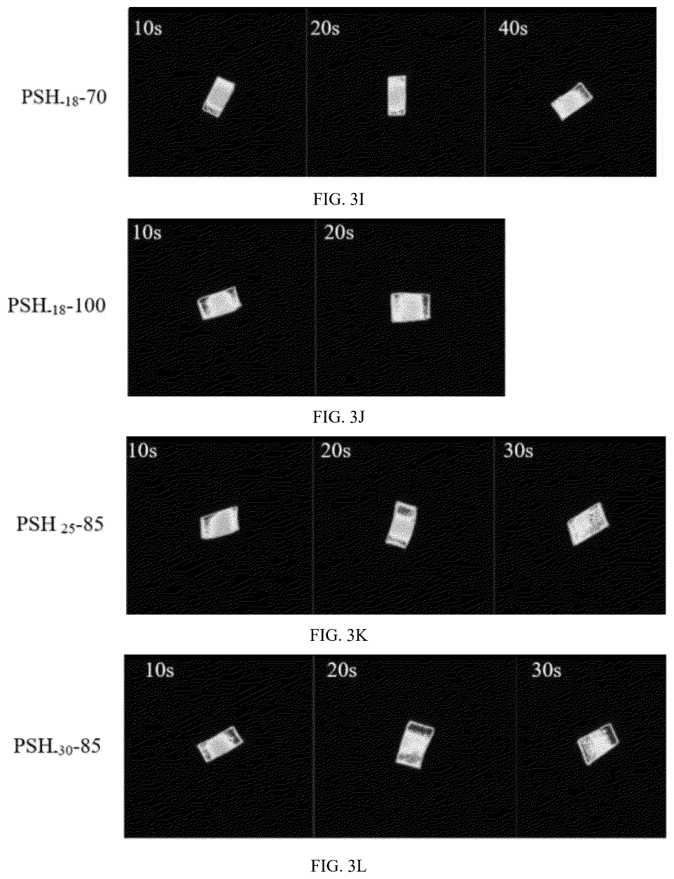

FIGS. 3A-3L are the MRI images of the potato starch gel. With the increase of rehydration temperature and time, water moves and diffuses from the outside of PSH to the inside, the peripheral pseudo-color of PSH changes from green to yellow-green and then to red, and the green area of the center gradually shrinks until it disappears, when the rehydration time increases, water gradually penetrates the PSH, and most of the time in the first stage is spent outside. Compared with 85° C. and 100° C., the water absorption is weak after rehydration at 70° C., it can be seen from the MRI image that the larger area is yellow-green. For the PSH₋₁₈ sample, as the rehydration time increases from 10 s to 20 s, when the proton density is higher, the moisture content is higher. Therefore, during the rehydration process, the absorption of starch gel water is regulated by the rehydration temperature and time, when the rehydration temperature is higher, the water absorption rate of the starch gel is faster, and the permeability of water will be affected by aging temperature. When the aging temperature is −18° C., water molecules will be frozen into small ice crystals. When freeze-aged potato starch is in a gel process, the water of the starch gel quickly freezes into small ice crystals at lower temperatures (−18° C., −30° C.). The increase of ice crystals may squeeze the potato starch gel, which to some extent destroys the structure of the potato starch gel, and the pore size of the internal gel becomes larger due to the freezing and melting of ice crystals. Finally, T23 turns to the right and the area of A23 increases. These large holes are conducive to the rapid migration of water. It is concluded that the larger pores in the loose structure may help to absorb more water. FIG. 7 is the moisture content of PSH at different aging temperatures, different rehydration temperatures, and times due to the short rehydration time during cooking. For all samples, the moisture content of PSH increases slowly. Compared with other aging temperatures, the moisture content of PSH₋₁₈ is higher than that of other samples.

### 2.4 PSH Scanning Electron Microscope:

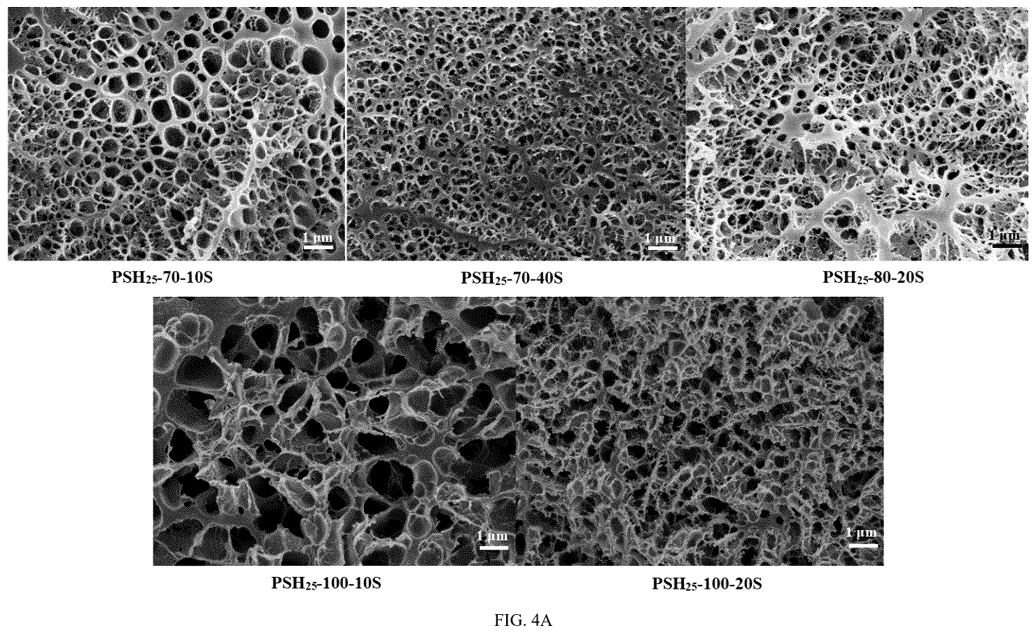

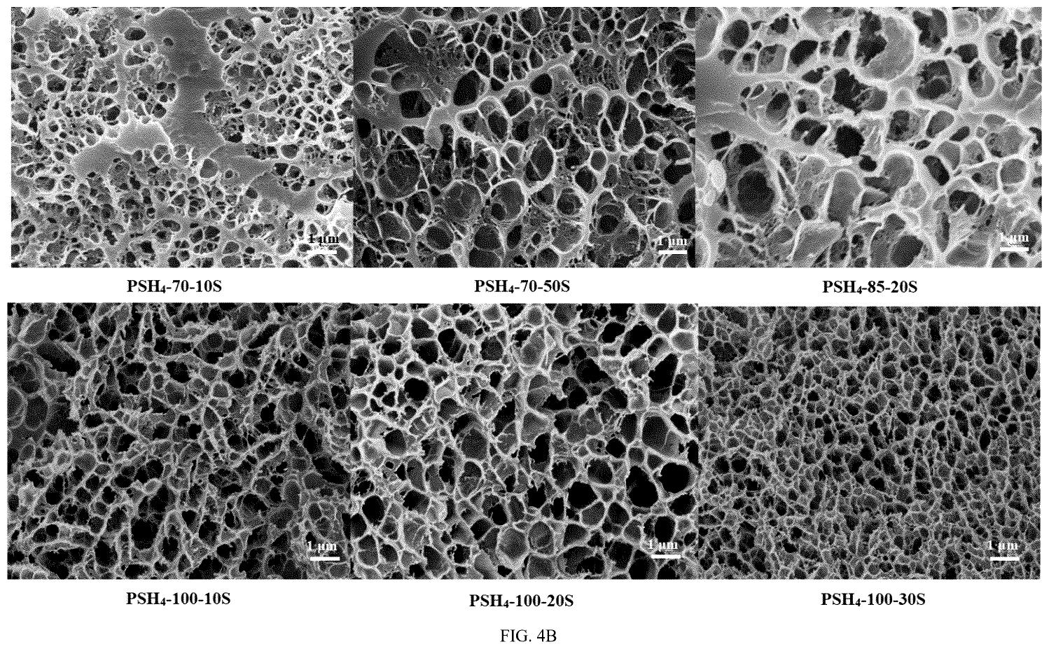

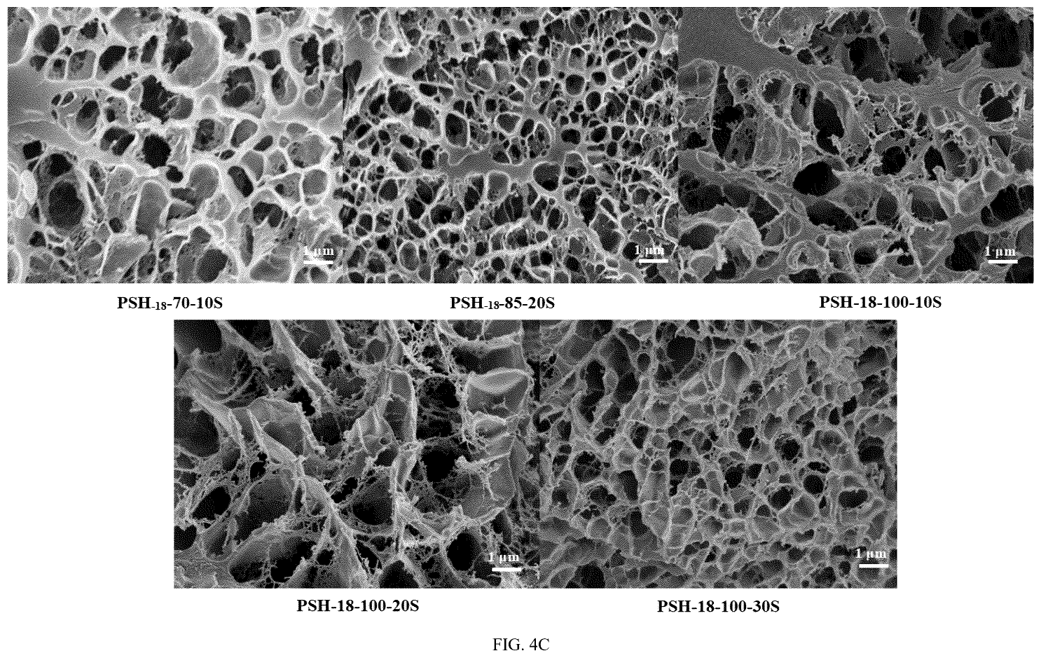

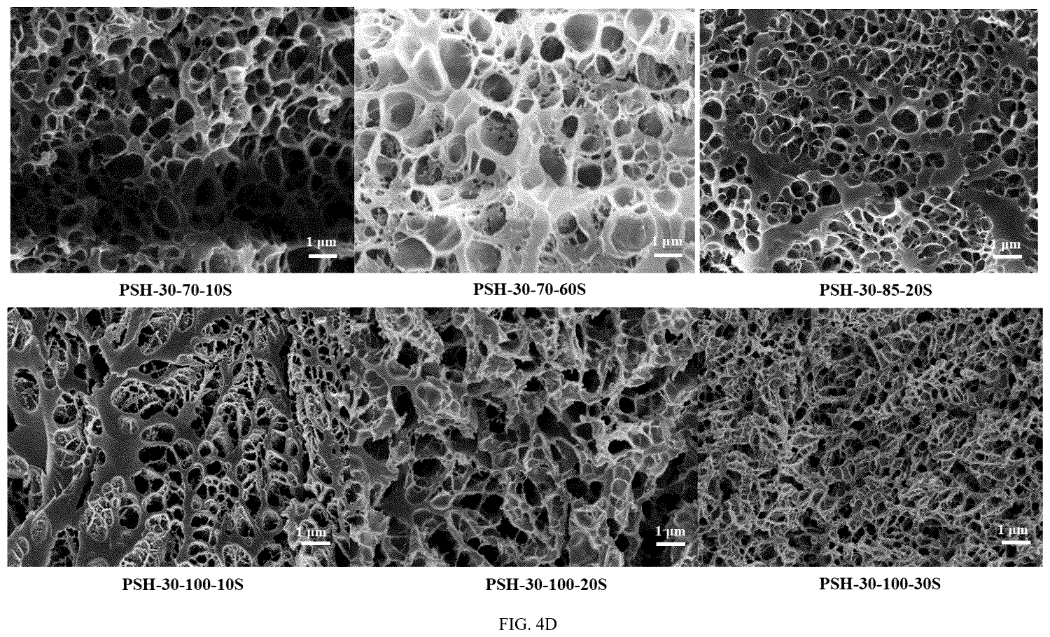

FIGS. 4A-4D are the gel microstructures of the potato starch gel regenerated at different temperatures and rehydrated at different temperatures. It can be seen from FIGS. 4A-4D that the gelatinized gel rehydrates at different temperatures and shows a network structure after freeze-drying, different temperature conditions lead to different degrees of regeneration, so the uniformity of the size of the gel network structure is not the same. With the decrease in aging temperature, the microscopic pore structure of all gel samples changed greatly. The pore structure gradually changes from fine and dense pore structure to large and uneven pore structure, and the mesh wall gradually changes from thin to thick. The pore structure of the gel after freezing aging at −18° C. is denser than that at 4° C. and room temperature. The reason is that the starch gel freezes rapidly at −18° C., and the surrounding nuclei do not form large ice crystals but form smaller ice crystals during the refrigeration process, thus forming a stable dense structure, improving the strength of the starch gel and inhibiting the aging of the starch gel, resulting in the relative density of the gel voids after freeze-drying. With the increase of rehydration temperature, the microscopic pore structure of all PSH gel samples changes greatly, and the pore structure gradually changes into a larger pore structure.

### 2.5 FTIR Spectra:

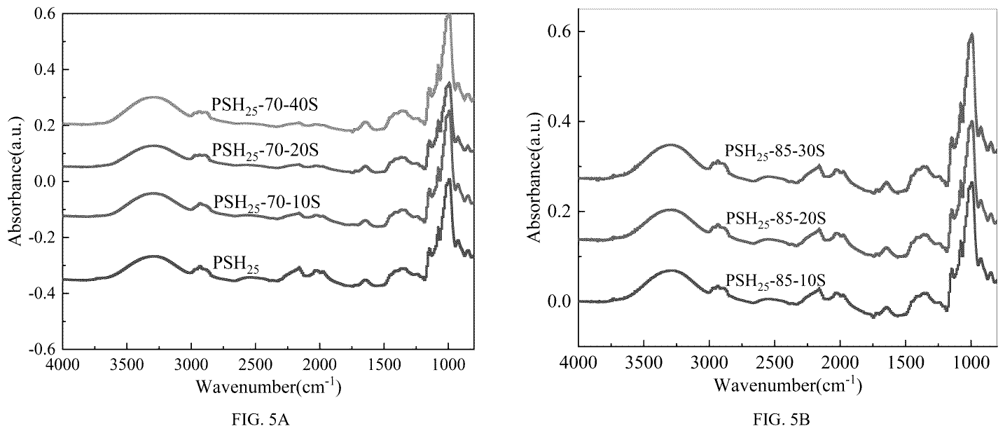

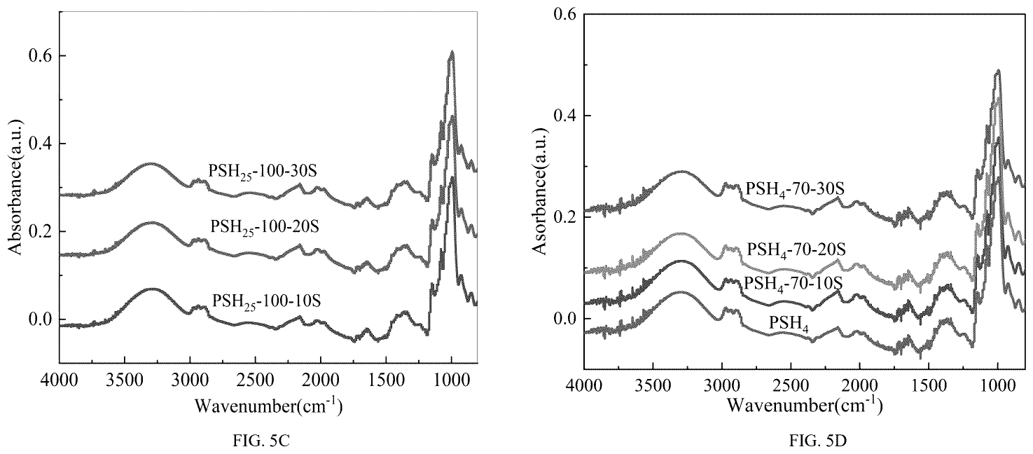

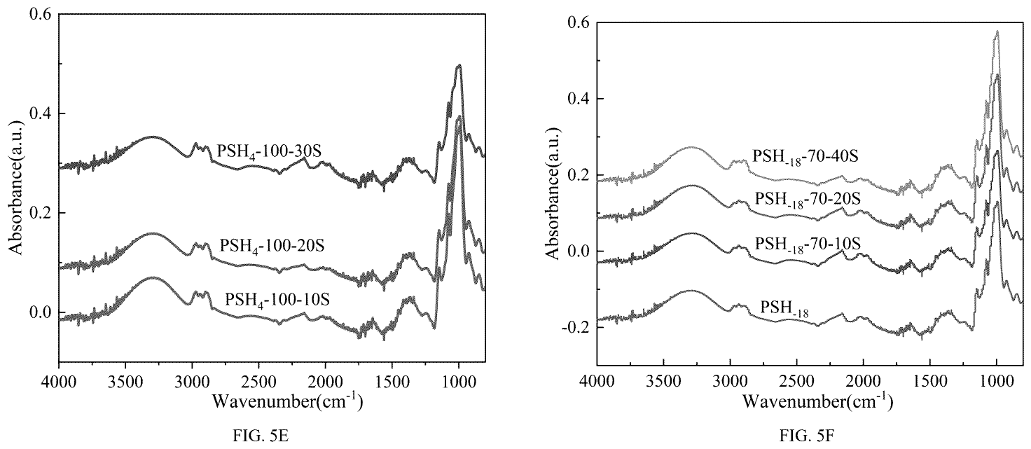

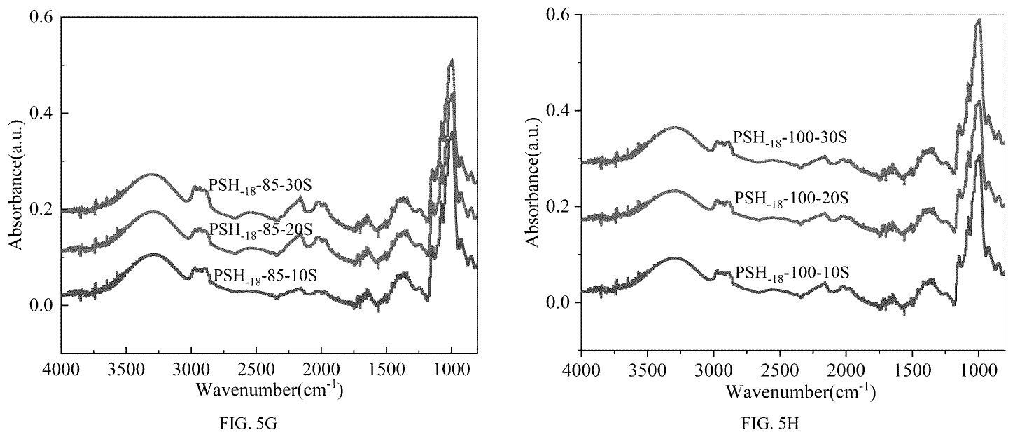

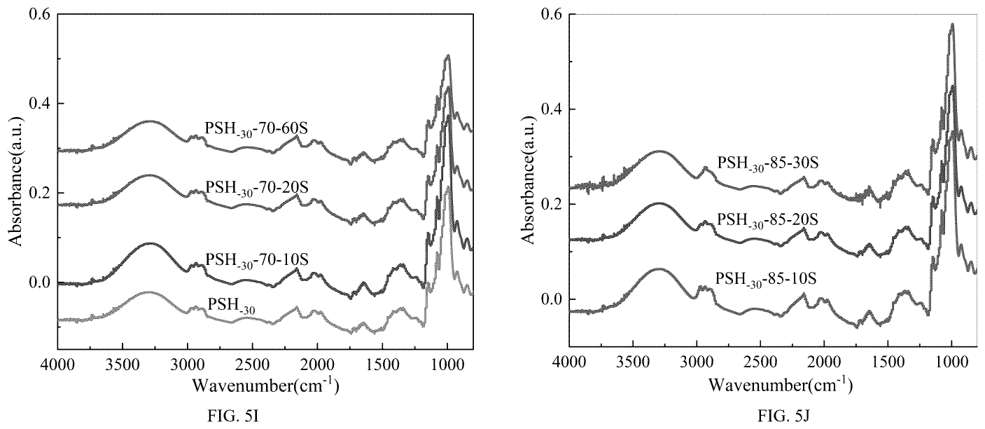

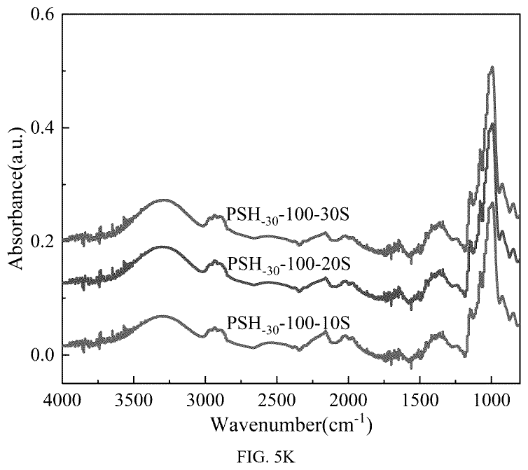

FIGS. 5A-5K are the infrared spectra of the potato starch gel under different regeneration temperatures and different rehydration conditions. The degradation of starch forms a double helix structure and constitutes a short-range ordered structure of the potato starch. The infrared spectra of potato starch gel at different regeneration temperatures and different rehydration conditions are basically similar, indicating that only the number of ordered structures changes during the gel regeneration process, and no other functional groups are produced or changed. Therefore, starch gel mainly relies on hydrogen bond interaction to form a network structure. The peak at 3000-3500 cm⁻¹ is the intermolecular-OH stretching vibration of the typical absorption band, and the absorption peaks at 1022 and 1047 cm⁻¹ correspond to the amorphous and crystalline regions in the starch granules, respectively. The ratio of 1047/1022 cm⁻¹ represents the degree of short-range order of starch molecules. The short-term ordered structure specifically refers to the single-helix and double-helix structures formed by amylose and amylopectin molecules. The retrograde of starch will form a double helix structure, which also constitutes the short-range ordered structure of the potato starch. It can be seen from FIGS. 5A-5K that all the peaks of the infrared spectra of the potato starch gel produced at different aging temperatures are basically similar, indicating that only the ordered structure changes during the gel aging process, and other functional groups are not produced or changed. Therefore, R1047/1022 is used to reflect the short-range order of starch crystals. Under the same conditions, the values R1047/1022 of PSH₂₅, PSH₄, PSH₋₁₈, and PSH-30 samples aged at different temperatures are 0.35, 0.53, 0.46 and 0.41, respectively; it shows that the starch is rapidly aged at 4° C., and the formed short-range order is more, and the crystallinity is more, and the freezing reduces the short-range ordered structure. As the rehydration temperature and time increase, it also increases the absorbance ratio of 1047/1022 cm⁻¹, indicating that high temperature promotes the growth of the short-range ordered starch molecules.

The above results show that the freeze aging (−18° C., −30° C.) caused the starch gel to freeze rapidly, and no large ice crystals were formed around the core. On the contrary, small ice crystals are formed during the cooling process, resulting in the formation of a stable and dense structure, thereby enhancing the strength of the starch gel. Compared with the aging temperature of 4° C. and 25° C., the potato gel under the condition of freezing aging shows superior mechanical properties. The tensile strength of PSH₋₁₈-100-20S is 750%-800% at −18° C. In addition, the results of the low-field nuclear magnetic resonance show that there are significant differences in the water content of the potato starch gel after aging at different temperatures. Under freezing conditions, due to the freezing and melting of ice crystals, the increase of the internal pore size accelerates the migration of water molecules, resulting in T23 shifting to the right. MRI results also show that with the increase of the rehydration temperature and time, water diffuses from the external area of potato starch gel to the internal area, and the water absorption rate is very fast. The porous structure formed by freezing aging increases the specific surface area, which is conducive to the migration of water molecules and shortens the rehydration time. In summary, the study shows that the microstructure formed by freeze aging is an effective strategy to enhance the mechanical properties and rehydration properties of starch gels, which provides a theoretical basis for the application of starch gels in food.

Therefore, the invention uses the above-mentioned tensile-resistant potato starch hydrogel and a preparation method thereof to obtain a starch hydrogel PSH₋₁₈-100-20S with excellent tensile strength, and the tensile strength is 750%-800%, the preparation parameters provide a theoretical basis for the application of starch hydrogels in food.

Finally, it should be explained that the above embodiments are only used to explain the technical scheme of the invention rather than restrict it. Although the invention is described in detail concerning the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. A preparation method for an anti-stretch potato starch hydrogel, comprising the following steps:
S1, a preparation of gel slices: mixing a potato starch and deionized water in a proportion, stirring evenly to form a slurry, pouring 4 mL of the slurry into a silica gel mold each time, placing the silica gel mold containing the slurry in a steamer, after boiling for 3-4 min, obtaining potato starch gel slices, and sealing the potato starch gel slices to obtain sealed potato starch gel slices and cooling the sealed potato starch gel slices at a room temperature to obtain cooled potato starch gel slices;
S2, aging of the gel slices: obtaining PSH₂₅, PSH₄, PSH₋₁₈, and PSH₋₃₀ by aging the cooled potato starch gel slices for 12 h;
S3, a rehydration of the gel slices: rehydrating the PSH₂₅, the PSH₄, the PSH₋₁₈, and the PSH₋₃₀ to obtain an anti-stretch potato starch hydrogel PSHₓ-Y-Z, wherein X is an aging temperature of the cooled potato starch gel slices, Y is a rehydration temperature, and Z is a rehydration time;
S4, a tensile property test and a texture property test: testing a tensile property and a texture property of the anti-stretch potato starch hydrogel PSHₓ-Y-Z by TG probe of a texture analyzer; and
S5, determining an optimal aging time of the anti-stretch potato starch hydrogel, an optimal rehydration temperature of the anti-stretch potato starch hydrogel, and an optimal rehydration time of the anti-stretch potato starch hydrogel.

2. The preparation method for the anti-stretch potato starch hydrogel according to claim 1, wherein a w/v ratio of the potato starch to the deionized water in the step S1 is 2:3, and a thickness of the potato starch gel slices is 1.5-3.0 mm.

3. The preparation method for the anti-stretch potato starch hydrogel according to claim 1, wherein the aging temperature of the cooled potato starch gel slices in the step S2 comprises 25° C., 4° C., −18° C., and −30° C.

4. The preparation method for the anti-stretch potato starch hydrogel according to claim 1, wherein the rehydration temperature in the step S3 comprises 70° C., 85° C., and 100° C., and the rehydration time comprises 10 s, 20 s, 30 s, 40 s, and 50 s.

5. The preparation method for the anti-stretch potato starch hydrogel according to claim 1, wherein an operation of the tensile property test in the step S4 is as follows: drying a surface of the anti-stretch potato starch hydrogel PSHₓ-Y-Z to obtain a dried potato starch hydrogel, and selecting the dried potato starch hydrogel with a uniform thickness for a measurement to obtain a stress-strain curve; and setting parameters as follows: an automatic displacement trigger mode, wherein a speed before the tensile property test is 3 mm/s, a speed during the tensile property test is 1 mm/s, a speed after the tensile property test is 3 mm/s, a sample width is 2 mm, a sample length is 18 mm, and a sample strain height is 10 mm.

6. The preparation method for the anti-stretch potato starch hydrogel according to claim 1, wherein an operation of the texture property test in the step S4 is as follows: drying a surface of the anti-stretch potato starch hydrogel PSHₓ-Y-Z to obtain a dried potato starch hydrogel, and selecting the dried potato starch hydrogel with a uniform thickness for a measurement; and setting parameters as follows: wherein a speed of the texture property test is 0.5 mm/s, a morphology of the texture property test is 50%, a pre-test speed of the texture property test and a post-test speed of the texture property test are 3 mm/s, and a trigger force of the texture property test is 5 g, obtaining a force-time curve by a texture analysis, obtaining texture parameters comprising a hardness, a viscosity, an elasticity, an adhesion, and a chewiness.

7. The preparation method for the anti-stretch potato starch hydrogel according to claim 1, wherein the optimal aging time of the anti-stretch potato starch hydrogel in the step S5 is −18° C., the optimal rehydration temperature of the anti-stretch potato starch hydrogel is 100° C., and the optimal rehydration time of the anti-stretch potato starch hydrogel is 20 s.

8. The preparation method for the anti-stretch potato starch hydrogel according to claim 7, wherein a tensile strength of the anti-stretch potato starch hydrogel is 750%-800% under conditions of the optimal aging time of the anti-stretch potato starch hydrogel, the optimal rehydration temperature of the anti-stretch potato starch hydrogel, and the optimal rehydration time of the anti-stretch potato starch hydrogel.

9. An anti-stretch potato starch hydrogel, wherein the anti-stretch potato starch hydrogel is prepared by the preparation method for the anti-stretch potato starch hydrogel according to claim 1.

10. The anti-stretch potato starch hydrogel according to claim 9, wherein in the preparation method for the anti-stretch potato starch hydrogel, a w/v ratio of the potato starch to the deionized water in the step S1 is 2:3, and a thickness of the potato starch gel slices is 1.5-3.0 mm.

11. The anti-stretch potato starch hydrogel according to claim 9, wherein in the preparation method for the anti-stretch potato starch hydrogel, the aging temperature of the cooled potato starch gel slices in the step S2 comprises 25° C., 4° C., −18° C., and −30° C.

12. The anti-stretch potato starch hydrogel according to claim 9, wherein in the preparation method for the anti-stretch potato starch hydrogel, the rehydration temperature in the step S3 comprises 70° C., 85° C., and 100° C., and the rehydration time comprises 10 s, 20 s, 30 s, 40 s, and 50 s.

13. The anti-stretch potato starch hydrogel according to claim 9, wherein in the preparation method for the anti-stretch potato starch hydrogel, an operation of the tensile property test in the step S4 is as follows: drying a surface of the anti-stretch potato starch hydrogel PSHₓ-Y-Z to obtain a dried potato starch hydrogel, and selecting the dried potato starch hydrogel with a uniform thickness for a measurement to obtain a stress-strain curve; and setting parameters as follows: an automatic displacement trigger mode, wherein a speed before the tensile property test is 3 mm/s, a speed during the tensile property test is 1 mm/s, a speed after the tensile property test is 3 mm/s, a sample width is 2 mm, a sample length is 18 mm, and a sample strain height is 10 mm.

14. The anti-stretch potato starch hydrogel according to claim 9, wherein in the preparation method for the anti-stretch potato starch hydrogel, an operation of the texture property test in the step S4 is as follows: drying a surface of the anti-stretch potato starch hydrogel PSHₓ-Y-Z to obtain a dried potato starch hydrogel, and selecting the dried potato starch hydrogel with a uniform thickness for a measurement; and setting parameters as follows: wherein a speed of the texture property test is 0.5 mm/s, a morphology of the texture property test is 50%, a pre-test speed of the texture property test and a post-test speed of the texture property test are 3 mm/s, and a trigger force of the texture property test is 5 g, obtaining a force-time curve by a texture analysis, obtaining texture parameters comprising a hardness, a viscosity, an elasticity, an adhesion, and a chewiness.

15. The anti-stretch potato starch hydrogel according to claim 9, wherein the optimal aging time of the anti-stretch potato starch hydrogel in the step S5 is −18° C., the optimal rehydration temperature of the anti-stretch potato starch hydrogel is 100° C., and the optimal rehydration time of the anti-stretch potato starch hydrogel is 20 s.

16. The anti-stretch potato starch hydrogel according to claim 15, wherein a tensile strength of the anti-stretch potato starch hydrogel is 750%-800% under conditions of the optimal aging time of the anti-stretch potato starch hydrogel, the optimal rehydration temperature of the anti-stretch potato starch hydrogel, and the optimal rehydration time of the anti-stretch potato starch hydrogel.
